(19) United States
(12) Patent Application Publication
(10) Pub. No.: US 2008/0109252 A1
(43) Pub. Date: May 8, 2008

(54) Predicting patient compliance with medical treatment

(76) Inventors: Andrea LaFountain, Wallingford, PA (US); Brooke S. Taylor, Pittsgrove, NJ (US); Kircia Casten, Cherry Hill, NJ (US)

Correspondence Address: ROPES & GRAY LLP, PATENT DOCKETING 39/361, 1211 AVENUE OF THE AMERICAS, NEW YORK, NY, 10036-8704, US

(21) Appl. No.: 11/595,169

(22) Filed: Nov. 8, 2006

(51) Int. Cl. G06Q 50/00

(52) U.S. Cl. 705/2

(57) ABSTRACT

Methods for predicting a patient's adherence to a medical treatment and optimizing the patient's treatment are provided. A questionnaire is developed using statistical analysis and/or mathematical modeling of factors affecting patient adherence, and is administered to a patient. Such factors may include the patient's openness to being persuaded to adhere to the medical regimen, the patient's perception of the risks and benefits associated with the medical regimen, and/or other patient-related factors. Based on the patient's answers to the questionnaire, a degree of adherence to the medical regimen associated with the patient is predicted and an intervention program is recommended to improve the patient's compliance with the treatment plan in the regimen.

### FIELD OF THE INVENTION

This invention relates to predicting patient compliance with treatment, and particularly to methods for predicting whether a patient adheres to a prescribed medical regimen.

### BACKGROUND OF THE INVENTION

Studies have shown that patients decide to stop taking their prescribed medication sooner than they are directed to. Such a decision can lead to a decrease in the overall effectiveness of a patient's treatment and can have other consequences affecting the patient's health. Such consequences can be serious and can even be deadly when the medication is prescribed to treat illnesses such as heart disease, diabetes and cancer. Other detrimental consequences can include tissue rejection in transplant recipients, hypertension, unintended pregnancies in women, etc. At the very least, non-compliance with treatment can lead to increased physician consultations, higher hospitalization rates and longer hospital stays.

Compliance with breast cancer treatments is an area of particular concern because of how common this type of non-skin cancer is in women. It would be desirable to improve patient compliance with these and other treatments. One way to do so is to identify the factors that most closely affect compliance and influence these factors in a way that increases compliance.

Patient compliance refers to the degree to which a patient adheres to a prescribed medical regimen. Adherence, or persistence, refers to the continued use of the regimen as prescribed, whereas non-compliance refers to deviation from the prescribed regimen. Adherence can depend on a number of factors that determine the overall burden of treatment: potential side effects, ease of use, the complexity of the regimen, the patient's willingness to undertake the treatment, social support, etc.

The World Health Organization (WHO) has established a framework that examines the interactions between the various factors that affect adherence. FIG. 1 shows the five main factors identified by the WHO as influencing patient adherence: socio-economic factors 102, therapy-related factors 104, patient-related factors 106, condition-related factors 108, and health system-related factors 110. For example, an inadequate education and a poor doctor-patient relationship can negatively affect adherence. So can depression or drug and alcohol abuse. Similarly, side effects of medications and duration of treatment may discourage patients from adhering to a medication regimen. Also, patients' knowledge and beliefs about their illnesses, as well as their motivation to manage their illnesses, may positively or negatively affect adherence.

Accordingly, in order to improve patient compliance, it would be desirable to focus on the factors that are identified in the WHO framework as affecting adherence and that may be influenced by, for example, a health care provider (HCP). Such factors may include patient-related factors, such as perceptions, beliefs, and expectations. Other factors in the WHO framework related to therapy, the health care system, socio-economic status, and condition may not be easily influenced in a patient. For example, some of these factors may not be changed by a medical practitioner (e.g., a patient's income), or may take a long time to change (e.g., how health care is delivered). Moreover, it would be desirable to identify which ones of these patient-related factors influence patient adherence the most.

Therefore, it would be desirable to provide methods for predicting a patient's adherence to a medical regimen based on key factors that affect patient adherence, and optimizing the patient's medical treatment by influencing such factors.

### SUMMARY OF THE INVENTION

It is an object of this invention to provide methods for predicting a patient's adherence to a medical regimen based on key factors that affect patient adherence, and optimizing the patient's medical treatment by influencing such factors.

This and other objects of the present invention are accomplished by administering a plurality of questions to the patient. The questions may relate to factors that correlate to and affect patient adherence to treatment. In certain embodiments of the present invention, such factors are ones that correlate most to, and affect, patient adherence. In addition, such factors may be ones that can be more easily influenced through the construction of an intervention program to improve patient adherence. The questions may therefore address one or more patient-related factors such as a patient's openness to being persuaded to adhere to the medical regimen, a patient's perception of the risks and benefits associated with the medical regimen, etc.

The questions may be derived by identifying measures that display adequate psychometric properties with respect to patient-related factors affecting patient adherence, conducting a survey of a group of patients based on these measures, applying statistical methods and/or mathematic modelling to analyze results from the survey and determine key factors that are predictive of intention to persist, and tailoring the questions so that they are based on at least a subset of the key factors.

More particularly, measures that may be taken into account can be any of Multidimensional Health Locus of Control Scale, Strategies Used by Patients to Promote Health, SF-12 , Life Orientation Test-Revised, Beck Depression Inventory-II, State Trait Anxiety Inventory, and Healthcare System Distrust Scale, as well as any other suitable measure developed for the purpose of conducting the survey, such as measures to assess beliefs, attitudes, social support, and intention to persist. The statistical methods and/or mathematic models applied may relate to factor analysis, cluster analysis, cluster partitioning, univariate logistic and partial least square regressions, principal component analysis, and structural equation modelling.

Based on the patient's answers to the questions, a degree of adherence to the medical regimen associated with the patient may be predicted and an intervention program may be recommended to improve the patient's adherence to the treatment. For example, each question may be in the form of a statement in which the patient is asked to rate a degree to which the patient agrees with the statement. Thereafter, the degree of adherence to the medical regimen may be associated with a score calculated from summing each rating, or using some other suitable method, and the intervention program may be recommended based on the calculated score.

### BRIEF DESCRIPTION OF THE DRAWINGS

The above and other advantages of the invention will be more apparent upon consideration of the following detailed description, taken in conjunction with the accompanying drawings, in which like reference characters refer to like parts throughout, and in which:

FIG. 1 is a chart identifying factors used in a conventional framework that addresses patient adherence;

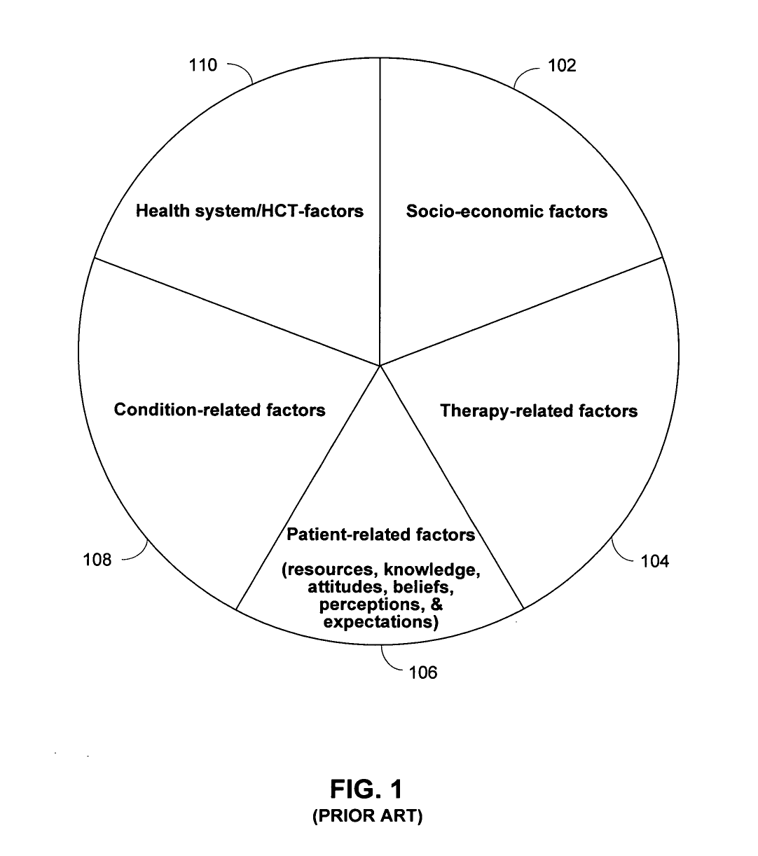

FIG. 2 is a preferred flow diagram of a process that may be used to identify key factors that can be used to predict patient adherence and develop a corresponding medical questionnaire in accordance with certain embodiments of the present invention;

FIG. 3 is a diagram showing exemplary results of the analysis and modeling performed in connection with the process of FIG. 2 as applied to patients taking hormonal therapy for breast cancer in accordance with certain embodiments of the present invention;

FIG. 4 is an exemplary questionnaire that may be administered to a patient in order to predict the patient's adherence to a medical regimen in accordance with certain embodiments of the present invention; and

FIG. 5 is a preferred flow diagram of a process that may be used to optimize a patient's medical treatment based on a prediction of the patient's adherence to a medical regimen in accordance with certain embodiments of the present invention.

### DETAILED DESCRIPTION OF THE INVENTION

The present invention is directed to methods for predicting a patient's adherence to a medical regimen and optimizing the patient's treatment based on the resulting prediction. To come up with a prediction for a particular patient's adherence to a prescribed medical regimen, a medical questionnaire may be administered to the patient and a prediction may be formed based on the patient's answers to the questions in the questionnaire. The questions in the questionnaire may be designed to address the factors that correlate to and affect patient adherence the most.

The factors influencing adherence can be complex and multifaceted. They may include socio-economic factors, beliefs and perceptions about benefits, risks and consequences, self-efficacy, anxiety, health locus of control, depression, optimism, distrust, openness to persuasion, and social influence. Because it is desirable to improve patient adherence to a given treatment, certain embodiments of the present invention focus on patient-related factors, such as perceptions, beliefs, and expectations, that can potentially be changed through patient-focused interventions. Other factors may not be influenced at all (e.g., due to ethical considerations or factors that are beyond the control of a medical practitioner), may take a long time to change, or may be prohibitively costly to influence.

As can be expected, the relationship between patient-related factors can be complicated and should be understood in order to develop an adequate questionnaire that can be administered to patients to predict patient adherence. For example, women who are suffering from breast cancer and are faced with long-term treatment may find themselves feeling conflicted when it comes to making medical decisions. For instance, if a woman who sees significant benefits from hormonal treatments is pressured by friends or family members who have strong feelings against such treatment, she is likely to become concerned and have a difficult time making a decision. Similarly, a woman may find it difficult to remain subject to adjuvant therapy when she believes that she is cancer-free and no longer wants to be bothered with cancer-related treatment despite her physician's recommendation.

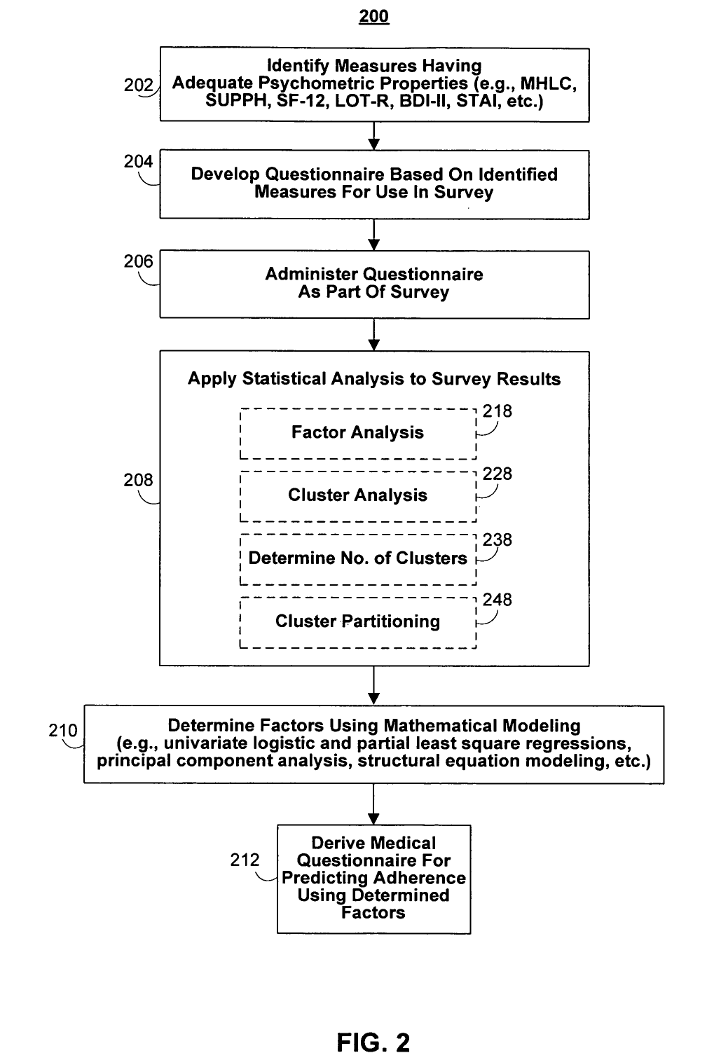

FIG. 2 describes a process 200 that uses statistical analysis and/or mathematical modeling in order to understand the effects and relationship between patient-related factors affecting adherence and, hence, identify which of these factors most strongly influence patient adherence in order to make up a medical questionnaire that can be used to predict patient adherence. Although some of the foregoing and following discussion relates to the treatment of breast cancer patients, the principles of the present invention may be applicable to any patient suffering from any ailment and subject to any medical treatment.

At step 202 of process 200, a collection of measures that can be used in a study of potential patient-related factors affecting patient adherence is identified. These measures may be chosen based on the psychometric properties they display. Psychometric properties are elements that contribute to the statistical adequacy of a measure in terms of, for example, reliability, validity, and internal consistency. Some of these measures may be already known from psychological theories of health-related behavior while others may be specifically developed for the study. The applicability of the psychological theories may be tested by grouping patients having varying degree of persistence into various focus groups. For example, patients may be grouped into two focus groups of persistent patients and two focus groups of non-persistent patients to determine drivers of behavior. Such groups may be moderated by a professional holding, for example, a PhD in Sociology. Moreover, quantitative factor analytic techniques may be used to create and test measures to be specifically used in the study using responses from the focus groups.

At step 204, a questionnaire may be developed for use in a survey of patients as part of the study to be conducted. The patient questionnaire may be based on some or all of the measures identified at step 202. Although the following discusses some of the measures that may be used, it is not meant to be an exhaustive list of all possible measures as other adequate measures may also be appropriate.

### Health Locus of Control

The Multidimensional Health Locus of Control Scale (MHLC) is an 18-item instrument that measures three dimensions of health locus of control. Respondents may rate how much they agree with a statement, such as: “Health professionals control my health” or “No matter what I do, if I am going to get sick, I will get sick.” The measure may yield individual scale scores for internality, powerful others, and chance locus of control. The responses are recorded on a 6-point Likert-type scale from “Strongly Disagree” to “Strongly Agree.” Dimensions may be summed to produce a separate total score for each subscale. The MHLC measure has been shown to have adequate psychometric properties. It displays good criterion validity, concurrent validity, and reliability.

### Self-Efficacy

The Strategies Used by Patients to Promote Health (SUPPH) scale is a 29-item self-report measure of self-care self-efficacy. It is a health-specific self-efficacy measure that is more likely to be predictive of health behavior than a more general measure. Self-efficacy may be measured by items assessing patients' confidence in carrying out certain self-care strategies. It measures four factors; coping, stress reductions, making decisions, and enjoying life. Examples of items from each factor are as follows: 1) coping—“keeping my stress within healthy limits,” 2) stress reduction—“practicing stress reduction techniques even when I am feeling sick,” 3) making decisions—“choosing among treatment alternatives recommended by my physician the one that seems right for me,” and 4) enjoying life—“helping other people going through treatment.”

Patients may be asked to rate the degree of confidence they have in carrying out these specific behaviors. They may rate the items on a five-point Likert-type scale of confidence ranging from 1 corresponding to “very little” to 5, corresponding to “quite a lot”. Scoring may be based on calculating a mean response across all items for each subscale. The SUPPH scale has been found to have adequate psychometric properties for administration in this investigation since the factors have also been found to be consistent with self-efficacy theory.

### Health-Related Quality of Life

The SF-12 is a 12-item self-report measure that measures health-related quality of life in two dimensions: mental and physical. The SF-12 was designed to measure general health status from the patient's point of view. It includes eight concepts commonly represented in health surveys: physical functioning, role functioning physical, bodily pain, general health, vitality, social functioning, role functioning emotional, and mental health. Results may be expressed in terms of two meta-scores: the Physical Component Summary (PCS) and the Mental Component Summary (MCS). The SF-12 measure may be scored so that a high score indicates better functioning. The SF-12 measure has been administered extensively for assessing health related quality of life across a number of dimensions. It has shown good reliability and validity and has been utilized in numerous studies.

### Dispositional Optimism

The Life Orientation Test-Revised (LOT-R) is a 10-item self-report measure developed to assess individual differences in generalized optimism versus pessimism. It has been used in research on behavioral, affective, and health consequences. Statements may be rated on a five-point Likert-type scale ranging from “I agree a lot” to “I disagree a lot.”This appears to measure “trait” optimism (as opposed to “state” optimism) with other optimism measures. It has been shown to possess adequate psychometric properties. Depression

The Beck Depression Inventory-I\I (BDI-II) is a 21-item self-report measure designed to be multiple- choice, and to be reflective of DSM-IV criteria for major depressive disorder. Patients may be asked to pick out one statement in each group of statements that describes the way they have been feeling over the past two weeks. The BDI-II measure has been used extensively in assessing the severity of depression and in detecting possible depression in the normal population.

### Anxiety

The State Trait Anxiety Inventory (STAI) measure consists of two separate 20-item self-report scales for measuring state anxiety and trait anxiety. The STAI-State scale requires people to describe how they feel at a particular moment in time and the STAI-Trait scale requires participants to describe how they generally feel. All statements on the STAI-State scale may be rated on a four-point Likert-type scale ranging from “Not at all” to “Very much so.” All statements on the STAI-Trait scale may be rated on a four-point Likert-type scale ranging from “Almost Always” to “Almost Never.” The STAI measure has been administered extensively for assessing anxiety in various populations. Its psychometric properties suggest that it is an adequate measure of both state and trait anxiety.

### Distrust

The Healthcare System Distrust Scale, a 10-item self-report measure was designed to measure healthcare-related trust and distrust. Trust may be defined as the belief by an individual that another entity would act in one's best interest in the future to prevent a potentially important negative outcome. Four of the ten items were designed to measure honesty, two items to measure confidentiality, two items to measure competence, and two items to measure fidelity. All ten statements may be rated on a five-point Likert-type scale ranging from “Strongly Disagree” to “Strongly Agree.” Preliminary reviews of this instrument show adequate psychometric properties.

### Readiness to Change

Stage of Change is one of four constructs in the Transtheoretical Model. It has most often been assessed using a single-item, multiple-choice format. This format has been used to measure stage of change in compliance with a prescribed medication. Participants in this study may therefore be asked to find the statement that best describes the way they currently feel about taking their medication as directed. The five choices of statements may represent each of the five states of change: precontemplation, contemplation, preparation, action, and maintenance. For example, the statement for precontemplation may be “I do not take and right now I am not considering taking my medication as directed.”

### Specific Beliefs, Attitudes, Social Support

Specific questions that can be used to assess certain beliefs, attitudes, and social support may be developed for the study. Sample questions/statements may be as follows: “I believe hormonal therapy is very likely to have dangerous side effects”; “I believe that hormonal therapy will provide me with the best chance of long-term survival”; If I do not take my hormonal therapy, I will blame myself if the cancer comes back”; “I think that hormonal therapy will prevent any recurrence of breast cancer”; “The benefits of taking hormonal therapy for breast cancer outweigh the costs”; “If I do not take hormonal therapy, I will not have to think about cancer treatment anymore”; “My spouse/partner plays an important role in my treatment and treatment decisions.”

### Intention to Take Hormonal Therapy

Although there may not be a validated formal measure of intention to persist that can be used as a proxy for persistence, one or more Likert-type question or statement may be used to assess such intent. For example, the question “how likely is it that you will return for your follow-up appointment?” may be used for assessing intent. A statement such as “I intend to conduct breast self-examination at least once each month over the next six months” may also or alternatively be used. Patients may respond on a seven-point Likert-scale ranging from “1” corresponding to “Extremely Unlikely” to “7” corresponding to “Extremely Likely.” Other examples include: 1) “intention to try to adopt healthier eating habits over the next four weeks” and 2) “intention to participate in physical activity about two times per week over the next four weeks.” The first question may assess desired intention, while the second may assess the self-prediction type of intention.

Participants in such an investigation may be asked to respond to five statements, embedded in the larger questionnaire, about intention to persist with treatment using a five-point Likert-type scale (from “1” corresponding to “Strongly Disagree” to “5” corresponding to “Strongly Agree”). Examples of such statements for breast cancer patients may be: 1) “I plan on taking my hormonal therapy even if I experience mild side effects”; “I plan on taking my hormonal therapy even if I experience moderate side effects”; “I plan on taking my hormonal therapy for the next year”; “I plan on taking my hormonal therapy even if I cannot tell whether it is helping me”; “I plan on taking my hormonal therapy even if I experience severe side effects.”

After the patient questionnaire is developed at step 204 of FIG. 2, it may be administered to a select group of patients at step 206 as part of the survey. Socio-economic and/or demographic data relating to the group of patients may also be obtained as part of the same or another survey. Such data may include each patient's age group, marital status, race, level of education, household income, etc. Other data may also be surveyed such as medical history, treatment history, etc.

The results of the survey conducted using the patient questionnaire may be analyzed at step 208 by applying statistical methods. For example, in accordance with certain embodiments of the present invention, patients may be divided into different clusters (groups) based on their reported intention to persist—e.g., two groups: persisters and non-persisters; or three groups: strong persisters, moderate persisters, and weak persisters. Accordingly, the number of clusters may be determined a priori. In alternative embodiments, a hierarchical tree clustering may be performed and the analysis of step 208 may follow the following sequence.

At step 218, a factor analysis may be performed to transform the reported intent to persist data into interval data, as well as to potentially reduce the information to a smaller number of factors. This step may provide a better understanding of the relationship among the statements identified above for assessing intention to persist, as well as the relationship between other factors. At step 228, the factor scores may then be entered into a cluster analysis, whereby Euclidian distance may be used to calculate similarities between subjects and the Ward method may be used to evaluate the distance between clusters (e.g., by minimizing the sum of squares of any two hypothetical clusters that can be formed at each step).

At step 238, the number of clusters to be retained may be defined by selecting a clustering level. The full hierarchical tree may be provided and the number of clusters may be made a posteriori using the descriptors of each cluster for each clustering level and the length of the branches. For example, a cluster analysis may determine three clusters based on responses to the five statements identified above for assessing intention to persist. At step 248, a partitioning clustering may be run with the number of clusters set to the number of clusters identified in the previous step. Such an analysis may provide an algorithm defining “intent to persist” clusters.

At step 210, mathematical modeling may be used to determine the factors for predicting patient adherence. In this step, univariate logistic and partial least square regressions may be performed to determine the predictors of the intention to persist with scale scores from the questionnaire. A principal component analysis using, e.g., Varimax rotation, may also be performed at step 210 to explore the structure of the factors retained by the model and refine the structural equation model. The model may be further refined at step 210 using structural equation modeling (SEM).

Also at step 210, Area Under the ROC (Receiver Operating Characteristics) curve may be used to assess the predictive performance of the model. Items that were statistically significant and/or items that were part of the SEM may be retained. Statistical significance may be set at a high percentage, such as 95%, 99%, or any other suitable level. In addition, the results may be subjected to a validation process. This may be achieved by divided the patients that were surveyed into a training set and a validation set, whereby the training set is analyzed first, and the validation set is then used to check the robustness of the conclusions drawn from the training set. In situations where the results are consistent between the two sets, consolidated results may be provided from the total set. In certain embodiments of the present invention, socio-economic, demographic, and/or medical data may be collected, as described above in connection with step 204, and also used in the validation process.

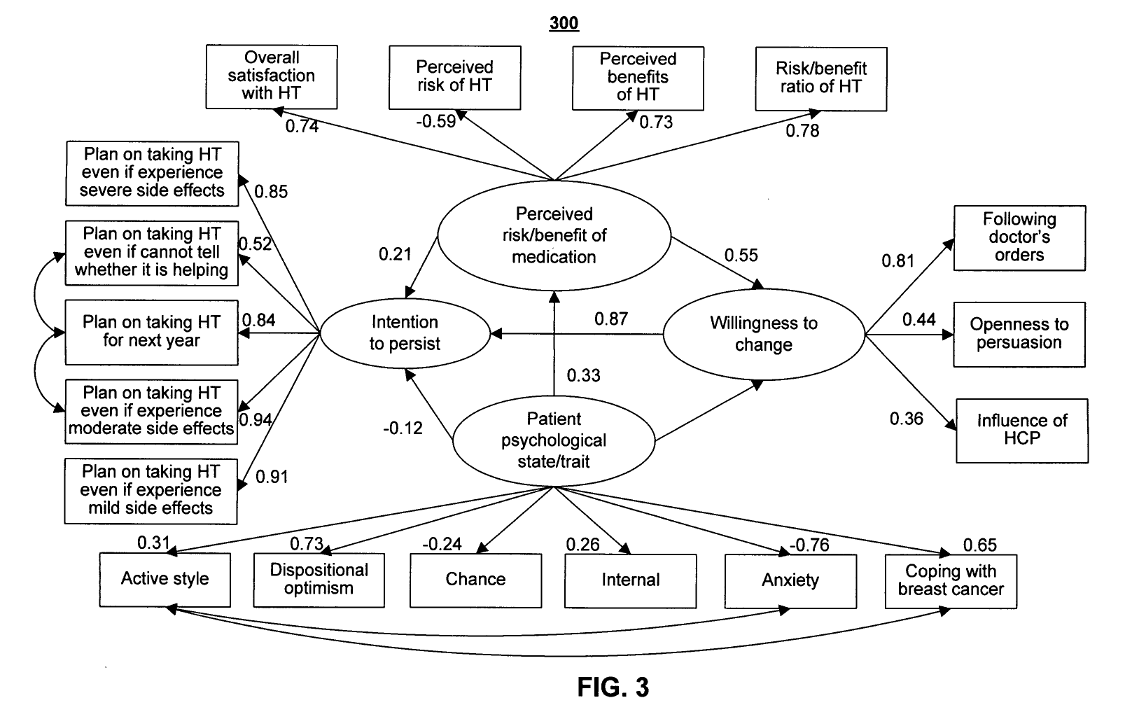

FIG. 3 shows the results of an exemplary model 300 outlining a number of factors that may be retained as being most predictive of the intention to persist from applying steps 206-210 of FIG. 2 to patients taking hormonal therapy (HT) for breast cancer. Model 300 shows the relationship between these factors (e.g., which factors influence each other), as well as their respective observed variable loadings (i.e., scaled numerical values reflecting the degree of correlation between these factors). For example, eighteen observable factors (shown in rectangles in model 300) may be retained in accordance with certain embodiments of the present invention. These observable factors may be grouped under four main, or latent, factors (shown in ovals in model 300), namely: patient psychological state/trait, perceived risk/benefit of medication, willingness to change, and intention to persist as follows.

Active style, dispositional optimism, chance, internal, anxiety, and coping with breast cancer may have the highest correlations with the patient psychological state/trait factor. Perceived risk-benefit ratio of hormonal therapy, perceived risks of hormonal therapy, perceived benefits of hormonal therapy, and overall satisfaction of hormonal therapy, may have the highest correlations with the perceived risk/benefit of medication factor. Following the orders of the health care provider, openness to persuasion, and influence of health care provider may have the highest correlations with the willingness to change factor. The five factors relating to taking hormonal therapy which may be found in the five statements identified above for assessing intention to persist may have the highest correlations with the intention to persist factor.

Another potential main factor (not shown in FIG. 3) that may be retained is a treatment history factor with which previous treatment for breast cancer and time since start of hormonal therapy may have the highest correlations.

The observed variable loadings on perceived risk/benefit of medication may be high. For example, they may range from −0.59 (perceived risk of hormonal therapy) to −0.78 (risk/benefit ratio of hormonal therapy). The observed variable loadings on willingness to change may be moderate to high. For example, they may range from 0.36 (influence of health care provider) to 0.81 (following doctor's orders). The observed variable loadings on patient psychological state/trait may be low to high. For example, the higher loadings were −0.76 (anxiety) and 0.73 (dispositional optimism), and the lower loadings were −0.24 (chance) and 0.26 (internal). When looking at the relation between the main factors, it may be determined that a patient's willingness to change has the highest impact on intention to persist (0.87), followed by the patient's perceived risk/benefit of medication (0.21) and the patient's psychological state/trait (−0.12).

A subset of all the factors shown in FIG. 3 may be used as a basis for questions that make up a medical questionnaire, which may be derived at step 212 of FIG. 2, for the purpose of predicting patient adherence. For example, one, two, three or more observable and/or latent factors may be used as bases for such questions. Alternatively, all factors may be used. However, considering the strongest impacts of the main factors on a patient's intention to persist, and considering what may be ethically or more easily, or substantially, influenced in a patient's behavior through intervention, it may be desirable to base the questions that make up the medical questionnaire on a patient's willingness or openness to being persuaded to take the medication and/or the patient's perception of the risks and benefits associated with the medication. These factors may be identified as being key factors for predicting patient adherence in certain embodiments of the present invention. However, questions may also or alternatively be based on the patient's psychological states and traits, especially in cases where the resulting intervention program is not intended to influence or affect this factor. Moreover, because it is most important to intervene early with patients who may have persistency problems, factors that may have content that is applicable to naive patients (i.e., patients starting their medical regimen relatively recently) may be retained.

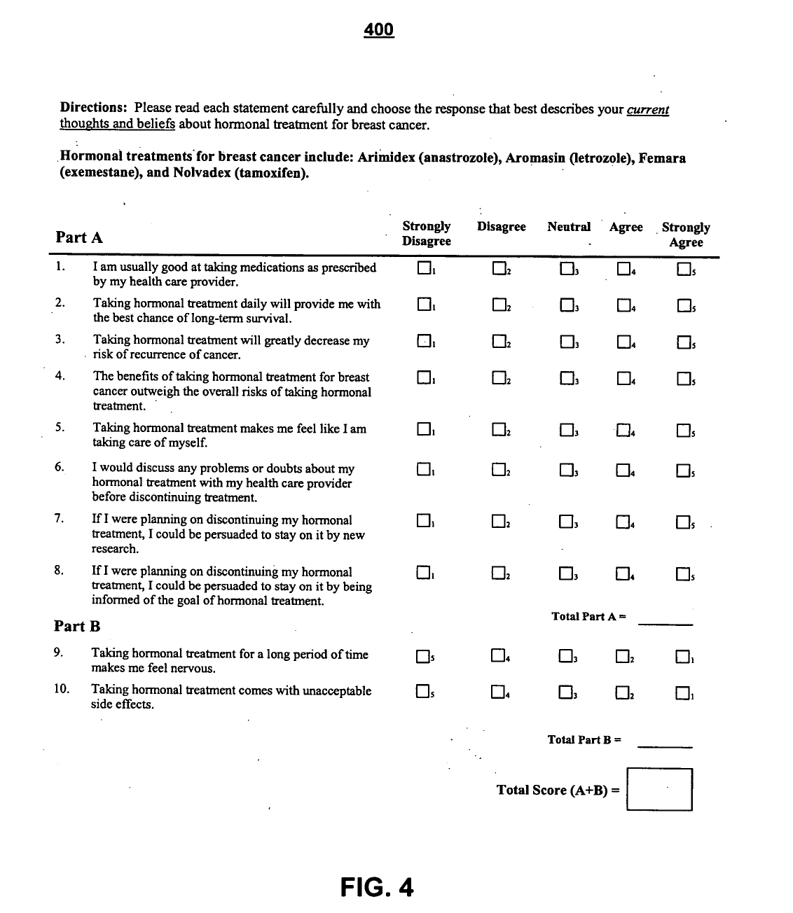

FIG. 4 shows an exemplary questionnaire 400 that may be constructed based on model 300 of FIG. 3 and administered to patients taking hormonal therapy for breast cancer. This sample questionnaire includes ten questions that either relate to patient openness to being persuaded to take medications or patient perception of the risks and benefits associated with medications. For example, the first statement, the sixth statement, the seventh statement, and the eighth statement relate to openness to persuasion while the others relate to risk/benefit perception.

In certain embodiments of the present invention, each question in the questionnaire may be in the form of a statement in which a patient is asked to rate the degree to which he or she agrees with that statement. A scale of 1 through 5 may be used as shown, such that a rating of “1” corresponds to “Strongly Disagree” and a rating of “5” corresponds to “Strongly Agree”, with higher ratings corresponding to higher levels of agreement with a particular statement. Depending on the phrasing of a particular statement, the rating for that statement (e.g., the last two statements of exemplary questionnaire 400) may be reversed such that higher ratings correspond to lower levels of agreement in order for the score reflect a more accurate prediction of adherence.

A patient score may be calculated from summing the ratings provided by a particular patient. The score may be summed for the entire questionnaire in a single addition or may be divided into two or more portions that may be summed separately. In exemplary questionnaire 400, the score is divided into two portions whereby the score for the statements for which the rating is reversed and the score for all other statements are summed separately. The total score may be determined by summing the separate scores for each portion. Missing answers are not replaced: if there is a question to which no answer was provided, the score may not be calculated. Scores may accordingly range from 10 to 50. Higher scores may indicate a higher intention to persist, hence better patient adherence.

Alternatively, the scale may contain 2, 3, 4, or any other number of ratings. For example, in some embodiments of the present invention, a scale of 1 through 3 may be used, such that a rating of “1” corresponds to “Disagree”, a rating of “2” corresponds to “Neutral”, and a rating of “3” corresponds to “Agree”. In this situation, scores may range from 10 to 30. In other embodiments of the present invention, the questionnaire may include any number of questions relating to any factor discussed above. Moreover, the degree of adherence to the medical regimen may be associated with a score calculated using any suitable method.

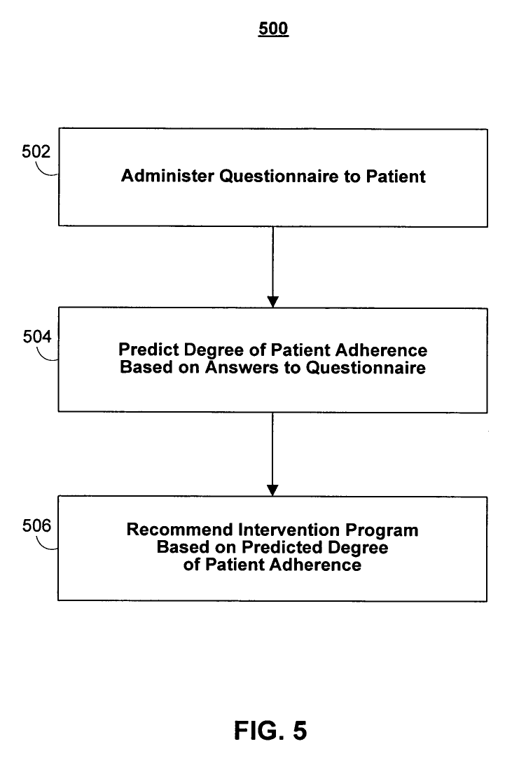

FIG. 5 describes a process 500 that can be used in accordance with certain embodiments of the present invention to optimize a patient's medical treatment based on a prediction of the patient's adherence to a medical regimen using a questionnaire such as the one shown in FIG. 4. A medical regimen may be a treatment plan that specifies the dosage, the schedule, and the duration of treatment and may be based on taking a series of medication, therapy, a combination of the same, or any other treatment.

At step 502 of process 500, a questionnaire may be administered to a particular patient. As discussed above, the questions in the questionnaire may relate to the patient's openness to being persuaded to adhere to the medical regimen, the patient's perception of the risks and benefits associated with the medical regimen, any other factor discussed above, or any combination thereof.

At step 504, a prediction is made as to the patient's degree of adherence to the medical regimen based on the patient's answers to the questions. This may be achieved by giving a patient a score associated with his or her answers to the questionnaire as discussed above in connection with FIG. 4, or using any other suitable mathematical formula or method. Higher scores may be associated with a prediction of better adherence. For example, a score higher than 40 may be associated with a prediction that the patient will adhere relatively well to the regimen, whereas a score lower than 40 may be associated with a prediction that the patient will not adhere well to the regimen.

At step 506, an intervention program may be recommended to improve the patient's adherence to the regimen based on the patient's predicted adherence, as determined at step 504. The recommended intervention program may be designed to further persuade the patient to take his or her medication and/or change the patient's perception of such medication. For example, a patient scoring a low score on the questionnaire may be given certain tools that may help the patient more regularly take his or her medication. This may include literature relating to the patient's illness and/or medication or therapy, memory aids, sample tests, personal counseling, measures to facilitate practitioner/patient dialog, and/or follow-up communications to verify whether the patient is taking his or her medication. The lower the score, the more extensive the program may be. On the other hand, a patient scoring a high score may not be subjected to any intervention.

The threshold for determining whether to intervene at all may be set to a particular score. This score may be predetermined and may be set at the conclusion of the validation process in which the robustness of results from the aforementioned study of patient-related factors is tested. The threshold score may be associated with the minimum level of actual adherence to a medical regimen that is considered acceptable with respect to the specific illness the medication is prescribed to treat. This minimum acceptable level of adherence may be derived from measures such as a medication possession ratio or any other suitable method for measuring actual adherence. For example, such a measure may be obtained through a sensor that is mounted on the pill dispenser that provides the patient with his or her prescribed medication. The sensor may detect and count the number of times the dispenser is opened or otherwise accessed.

In the above example, the threshold score may be set to 40. Accordingly, no intervention will be recommended for a patient scoring higher than 40 as compared to a patient scoring lower than 40. The closer the patient score is to 10, the more extensive the intervention will be.

In certain embodiments of the present invention, a decision as to whether to recommend an intervention program, or the intervention program itself, may be based on answers given to specific questions in the questionnaire. For example, if the questionnaire includes questions relating to two factors such as openness to persuasion and risk/benefit perception, then, an intervention program may not be recommended unless the patient scored poorly on questions directed to both factors, at least one of the factors, or only one of the factors. To do that, a first score may be calculated from summing each rating of the degree to which the patient agrees with the statements relating to the patient's openness to persuasion, and a second score is calculated from summing each rating of the degree to which the patient agrees with the statements relating to the patient's risk/benefit perception. The recommended intervention program may be focused on persuading the patient to take his or her medication if the total score is low but the first score is high. Alternatively, the recommended intervention program may be focused on changing the patient's perception of such medication if the total score is low but the second score is high. As another example, the intervention program may be tailored to address the factor(s) corresponding to the question(s) on which the patient scored poorly.

Thus it is seen that methods for predicting a patient's adherence to a medical treatment and optimizing the patient's treatment are provided. One skilled in the art will appreciate that the present invention can be practiced by other than the described embodiments, which are presented for purposes of illustration and not of limitation, and the present invention is limited only by the claims which follow.

What is claimed is:

1. A method for predicting a patient's adherence to a medical regimen, the method comprising:
administering a plurality of questions to the patient, the questions relating to at least one of: (1) the patient's openness to being persuaded to adhere to the medical regimen, and (2) the patient's perception of the risks and benefits associated with the medical regimen; and
determining a degree of adherence to the medical regimen associated with the patient based on the patient's answers to the questions.

2. The method of claim 1 wherein at least one the questions relates to the patient's psychological states and traits.

3. The method of claim 1 wherein:
each of the plurality of questions is in the form of a statement in which the patient is asked to rate a degree to which the patient agrees with the statement; and
the degree of adherence to the medical regimen is associated with a score calculated from summing each rating.

4. A method for optimizing a patient's medical treatment, the method comprising:
administering a plurality of questions to the patient, the questions relating to at least one of: (1) the patient's openness to being persuaded to adhere to a medical regimen, and (2) the patient's perception of the risks and benefits associated with the medical regimen;
predicting the patient's adherence to the medical regimen based on the patient's answers to the questions; and
recommending an intervention program for the patient based on the predicted adherence.

5. The method of claim 4 wherein each one of the plurality of questions is in the form of a statement in which the patient is asked to rate a degree to which the patient agrees with the statement.

6. The method of claim 5 wherein the degree of adherence to the medical regimen is associated with a score calculated from summing each rating.

7. The method of claim 6 wherein the recommended intervention program is based on the calculated score.

8. The method of claim 6 wherein no intervention program is recommended when the score associated with the degree of adherence is higher than a predetermined threshold.

9. The method of claim 5 wherein:
a first score is calculated from summing each rating of the degree to which the patient agrees with the statements relating to the patient's openness to being persuaded to adhere to the medical regimen; and
a second score is calculated from summing each rating of the degree to which the patient agrees with the statements relating to the patient's perception of the risks and benefits associated with the medical regimen.

10. The method of claim 9 wherein the recommended intervention program is based on the first and second scores.

11. A method for developing a questionnaire for use in predicting a patient's adherence to a medical regimen, the method comprising:
identifying measures that display adequate psychometric properties with respect to factors affecting patient adherence;
conducting a survey of a group of patients by administering to the patients a plurality of questions that are based on the identified measures;
analyzing the results from the conducted survey to determine key factors that are predictive of intention to persist with medical treatment; and
deriving a questionnaire based on at least a subset of the key factors.

12. The method of claim 11 wherein the identified measures comprise at least one measure that is selected from the group consisting of Multidimensional Health Locus of Control Scale, Strategies Used by Patients to Promote Health, SF-12 Life Orientation Test-Revised, Beck Depression Inventory-II, State Trait Anxiety Inventory, and Healthcare System Distrust Scale.

13. The method of claim 11 wherein the identified measures comprise at least one measure that is developed for the purpose of conducting the survey.

14. The method of claim 13 wherein the at least one measure is developed to assess beliefs, attitudes, and social support.

15. The method of claim 13 wherein the at least one measure is developed to assess intention to persist.

16. The method of claim 11 wherein the analyzing the results from the conducted survey comprises applying at least one of factor analysis, cluster analysis, and cluster partitioning.

17. The method of claim 11 wherein the analyzing the results from the conducted survey comprises applying at least one of univariate logistic and partial least square regressions, principal component analysis, and structural equation modelling.

18. The method of claim 11 wherein the deriving the questionnaire is further based on retaining factors that may be ethically influenced in a patient.

19. The method of claim 11 wherein the deriving the questionnaire is further based on retaining factors that may be substantially influenced in a patient.

20. The method of claim 11 wherein the derived questionnaire is based on patient openness to being persuaded to adhere to the medical regiment and patient perception of the risks and benefits associated with the medical regimen.
